(19) United States
(12) Patent Application Publication
(10) Pub. No.: US 2025/0212118 A1
(43) Pub. Date: Jun. 26, 2025

(54) METHOD, DEVICE AND SYSTEM FOR REDUCING FALSE WAKE-UP POWER CONSUMPTION

(71) Applicants: BEIJING JADE BIRD UNIVERSAL FIRE PROTECTION SYSTEM SOFTWARE SERVICE CO., LTD., Beijing (CN); Jachip Semiconductor (Shenzhen) Co., Ltd., Guangdong (CN); Jade Bird Fire Co., Ltd., Beijing (CN)

(72) Inventors: Yu GUO, Beijing (CN); Ming Yang, Beijing (CN)

(21) Appl. No.: 18/989,517

(22) Filed: Dec. 20, 2024

(30) Foreign Application Priority Data
Dec. 22, 2023 (CN) 202311794457X

(51) Int. Cl. H04W 52/02

(52) U.S. Cl. CPC H04W 52/0225

(57) ABSTRACT

The present disclosure provides a method for reducing false wake-up power consumption of a device. The method includes: opening a first receipt time window, and detecting whether a preamble exists in the air, the preamble being a code-modulated preamble; if no preamble is detected in the air, controlling the device to go to sleep; if the preamble is detected in the air, controlling the device to open a second receipt time window and receive a wake-up packet; detecting whether the wake-up packet meets a preset condition; if the wake-up packet does not meet the preset condition, controlling the device to go to sleep; and if the wake-up packet meets the preset condition, controlling the device to open a third receipt time window, receive communication information, process the communication information, and go to sleep after communication information processing is completed. In the present disclosure, by adopting a code-modulated preamble, the probability of false wake-up of the device can be effectively reduced, and the false wake-up power consumption of the device can be reduced; by setting a wake-up packet, the probability of false wake-up of the device can be further reduced, and the false wake-up power consumption of the device can be further reduced.

### TECHNICAL FIELD

The present disclosure generally relates to the field of wireless communications, and in particular, to a method for reducing false wake-up power consumption of a device, a device for reducing false wake-up power consumption, and a system for reducing false wake-up power consumption.

### BACKGROUND

In the field of wireless communications, the problem of false wake-up has been an important research subject. In the existing technical schemes, when a wireless communication networking system powered by batteries or having low power consumption implements the sleep/wake-up function, the networking mechanism generally chooses to adopt a manner such as a time-division multiple access (TDMA) time recurrent network or an active periodic reporting mode in which a receipt window is opened transitorily, so as to achieve periodic listening and monitor whether a device sends a wake-up communication signal. These methods have a high probability of false wake-up, high power consumption and a low success rate of device wake-up, and thus cannot meet the power consumption index requirements of low-power products. Especially for fire control products, if the false wake-up power consumption is large, the fire control products are prone to warning and alarm failure, causing potential safety hazards.

Therefore, a scheme to reduce the false wake-up power consumption of a device is urgently required.

The contents of the Background are merely technologies known to the inventors and do not necessarily represent the existing technologies in the art.

### SUMMARY

For one or more of the problems in the existing technologies, the present disclosure provides a method for reducing the false wake-up power consumption of a device.

The method includes:
opening a first receipt time window, and detecting whether a preamble exists in air, wherein the preamble is a code-modulated preamble;
if no preamble is detected in the air, controlling the device to go to sleep;
if the preamble is detected in the air, controlling the device to open a second receipt time window and receive a wake-up packet;
detecting whether the wake-up packet meets a preset condition;
if the wake-up packet does not meet the preset condition, controlling the device to go to sleep; and
if the wake-up packet meets the preset condition, controlling the device to open a third receipt time window, receive communication information, process the communication information, and go to sleep after communication information processing is completed.

According to an aspect of the present disclosure, the method includes:
scrambling the preamble with a random factor; and/or
adding first group number information of the device to the preamble.

According to an aspect of the present disclosure, the preamble includes a signal whose frequency increases over time and/or a signal whose frequency decreases over time, and a step of scrambling the preamble with a random factor includes: scrambling the signal whose frequency increases over time and/or the signal whose frequency decreases over time with a random factor.

According to an aspect of the present disclosure, a step of scrambling the signal whose frequency increases over time and/or the signal whose frequency decreases over time with a random factor includes:
dividing the signal whose frequency increases over time into a plurality of first time slices, and scrambling at least one of the plurality of first time slices with a random factor; and/or
dividing the signal whose frequency decreases over time into a plurality of second time slices, and scrambling at least one of the plurality of second time slices with a random factor.

According to an aspect of the present disclosure, a step of scrambling at least one of the plurality of first time slices with a random factor includes: dividing the at least one first time slice into a plurality of first sub-time slices, and scrambling at least one of the plurality of first sub-time slices with a random factor; and
wherein a step of scrambling at least one of the plurality of second time slices with a random factor includes: dividing the at least one second time slice into a plurality of second sub-time slices, and scrambling at least one of the plurality of second sub-time slices with a random factor.

According to an aspect of the present disclosure, a step of adding first group number information of the device to the preamble includes: adding the first group number information of the device to the signal whose frequency increases over time and/or the signal whose frequency decreases over time.

According to an aspect of the present disclosure, a step of adding the first group number information of the device to the signal whose frequency increases over time and/or the signal whose frequency decreases over time includes:
dividing the signal whose frequency increases over time into a plurality of first time slices, and adding the first group number information to at least one of the plurality of first time slices; and/or
dividing the signal whose frequency decreases over time into a plurality of second time slices, and adding the first group number information to at least one of the plurality of second time slices.

According to an aspect of the present disclosure, a step of adding the first group number information to at least one of the plurality of first time slices includes: dividing the at least one first time slice into a plurality of first sub-time slices, and adding the first group number information to at least one of the plurality of first sub-time slices; and
wherein a step of adding the first group number information to at least one of the plurality of second time slices includes: dividing the at least one second time slice into a plurality of second sub-time slices, and adding the first group number information to at least one of the plurality of second sub-time slices.

According to an aspect of the present disclosure, the preamble includes a frequency-varying signal whose starting frequency is non-zero, and the method includes:
scrambling the frequency-varying signal whose starting frequency is non-zero with a random factor; and/or
adding the first group number information of the device to the frequency-varying signal whose starting frequency is non-zero.

According to an aspect of the present disclosure, a step of detecting whether the wake-up packet meets a preset condition includes: detecting whether the wake-up packet matches the device.

According to an aspect of the present disclosure, the device includes first group number information; the wake-up packet includes second group number information; a step of detecting whether the wake-up packet matches the device includes: detecting whether the second group number information of the wake-up packet matches the first group number information of the device; and/or detecting whether the second group number information of the wake-up packet matches preset group number information, to detect whether the wake-up packet matches the device.

According to an aspect of the present disclosure, the first group number information is determined by one or more of a true random number, identity (ID) information of the device, and Universal Time Coordinated (UTC) time information.

According to an aspect of the present disclosure, the third receipt time window is longer than the second receipt time window.

According to an aspect of the present disclosure, a step of detecting whether a preamble exists in air includes: periodically opening the first receipt time window, and detecting whether the preamble exists in the air, wherein the first receipt time window is shorter than the second receipt time window.

According to an aspect of the present disclosure, a step of receiving communication information and processing the communication information includes: demodulating the communication information, and performing cyclic redundancy check (CRC) verification on the communication information; if the communication information passes the CRC verification, performing a decryption check on the communication information, and if the communication information passes the decryption check, controlling the device to go to sleep after the device executes a communication instruction; if the communication information fails the CRC verification or if the communication information fails the decryption check, controlling the device to go to sleep.

According to an aspect of the present disclosure, the device is capable of communicating with another device; the preamble is capable of being sent by the another device that gives an alarm; wherein the device and/or the another device includes a fire control device.

According to an aspect of the present disclosure, the method further includes: monitoring power consumption of the device, and controlling the device to perform the method at low power consumption.

The present disclosure further provides a device for reducing false wake-up power consumption, including:
a preamble detection module;
a wake-up packet recognition module communicating with the preamble detection module; and
a control module communicating with the preamble detection module and the wake-up packet recognition module respectively and controlling operation of the preamble detection module and the wake-up packet recognition module;
wherein the preamble detection module is configured to open a first receipt time window and detect whether a preamble exists in the air, wherein the preamble is a code-modulated preamble;
if the preamble detection module detects the preamble in the air, the wake-up packet recognition module is configured to open a second receipt time window, receive a wake-up packet, and detect whether the wake-up packet meets a preset condition;
if the wake-up packet recognition module determines that the wake-up packet meets the preset condition, the control module is configured to open a third receipt time window, receive communication information, process the communication information and control the device to go to sleep after communication information processing is completed;
the control module is further configured to, if the preamble detection module detects no preamble in the air, or if the wake-up packet recognition module determines that the wake-up packet does not meet the preset condition, control the device to go to sleep.

According to an aspect of the present disclosure, the control module is further configured to:
scramble the preamble with a random factor; and/or
add first group number information of the device to the preamble.

According to an aspect of the present disclosure, the preamble includes a signal whose frequency increases over time and/or a signal whose frequency decreases over time, and the control module is further configured to scramble the signal whose frequency increases over time and/or the signal whose frequency decreases over time with a random factor.

According to an aspect of the present disclosure, the control module is further configured to:
divide the signal whose frequency increases over time into a plurality of first time slices, and scramble at least one of the plurality of first time slices with a random factor; and/or
divide the signal whose frequency decreases over time into a plurality of second time slices, and scramble at least one of the plurality of second time slices with a random factor.

According to an aspect of the present disclosure, the control module is further configured to:
divide the at least one first time slice into a plurality of first sub-time slices, and scramble at least one of the plurality of first sub-time slices with a random factor; and/or
divide the at least one second time slice into a plurality of second sub-time slices, and scramble at least one of the plurality of second sub-time slices with a random factor.

According to an aspect of the present disclosure, the control module is further configured to:
add the first group number information of the device to the signal whose frequency increases over time and/or the signal whose frequency decreases over time.

According to an aspect of the present disclosure, the control module is further configured to:
divide the signal whose frequency increases over time into a plurality of first time slices, and add the first group number information to at least one of the plurality of first time slices; and/or
divide the signal whose frequency decreases over time into a plurality of second time slices, and add the first group number information to at least one of the plurality of second time slices.

According to an aspect of the present disclosure, the control module is further configured to:
divide the at least one first time slice into a plurality of first sub-time slices, and add the first group number information to at least one of the plurality of first sub-time slices; and/or
divide the at least one second time slice into a plurality of second sub-time slices, and add the first group number information to at least one of the plurality of second sub-time slices.

According to an aspect of the present disclosure, the preamble includes a frequency-varying signal whose starting frequency is non-zero, and the control module is further configured to:
scramble the frequency-varying signal whose starting frequency is non-zero with a random factor; and/or
add the first group number information of the device to the frequency-varying signal whose starting frequency is non-zero.

According to an aspect of the present disclosure, the wake-up packet recognition module is configured to detect whether the wake-up packet matches the device, to detect whether the wake-up packet meets the preset condition.

According to an aspect of the present disclosure, the device includes first group number information; the wake-up packet includes second group number information; the wake-up packet recognition module is configured to detect whether the second group number information of the wake-up packet matches the first group number information of the device, to detect whether the wake-up packet matches the device; and/or detect whether the second group number information of the wake-up packet matches preset group number information, to detect whether the wake-up packet matches the device.

According to an aspect of the present disclosure, the first group number information is determined by one or more of a true random number, identity (ID) information of the device, and Universal Time Coordinated (UTC) time information.

According to an aspect of the present disclosure, the third receipt time window is longer than the second receipt time window.

According to an aspect of the present disclosure, the preamble detection module is configured to periodically open the first receipt time window and detect whether the preamble exists in the air, wherein the first receipt time window is shorter than the second receipt time window.

According to an aspect of the present disclosure, the control module is configured to demodulate the communication information, and perform cyclic redundancy check (CRC) verification on the communication information; if the communication information passes the CRC verification, perform a decryption check on the communication information, and if the communication information passes the decryption check, control the device to go to sleep after the device executes a communication instruction; if the communication information fails the CRC verification, or if the communication information fails the decryption check, control the device to go to sleep.

According to an aspect of the present disclosure, the device is capable of communicating with another device; the preamble is capable of being sent by the another device that gives an alarm; wherein the device and/or the another device includes a fire control device.

According to an aspect of the present disclosure, the device further includes a power management module, wherein the power management module is configured to monitor power consumption of the device, to enable the preamble detection module, the wake-up packet recognition module and the control module to work at low power consumption.

The present disclosure further provides a system for reducing false wake-up power consumption, including a plurality of devices as described above, wherein each device is capable of executing the method as described above when another device gives an alarm and sends a preamble.

The present disclosure further provides a computer-readable storage medium including computer-executable instructions stored thereon, wherein the executable instructions, when executed by a processor, implement the method described above.

In summary, the method, device and system of the present disclosure are described in detail. In the schemes of the present disclosure, by optimizing the preamble and by adopting a code-modulated preamble, the probability of false wake-up of the device can be effectively reduced, and the false wake-up power consumption of the device can be reduced; by setting a wake-up packet, the problem that the devices within the same modulation system misrecognize each other can be solved, the probability of false wake-up of the device can be further reduced, and the false wake-up power consumption of the device can be further reduced; by optimizing the periodic detection and working in a TDMA periodic cycle mode, the time slice of the transmitter, the preamble or the packet time are not required to be concerned with, no high-precision hardware clock circuit is required, and the hardware cost and volume of the device can be reduced; the device or system of the present disclosure supports battery-powered operation and low-power operation, which is conducive to prolonging the service life of the battery and reducing the frequency of battery replacement, thereby meeting the requirements of the market for an ultra-long standby service life of the battery. The schemes of the present disclosure can be applied in the fields of fire control and smart home and have a wide range of applications, and multiple devices can freely form a non-cellular network, providing a high degree of flexibility. Compared to the existing technologies, the schemes of the present disclosure have a low probability of false wake-up, low power consumption, a wide range of applications and a high degree of flexibility, thereby meeting the requirements for low power consumption and a long standby duration, and when applied to a fire control equipment, can reduce the risk of warning and alarm failures of the fire control equipment, thereby providing a security guarantee for fire control.

### BRIEF DESCRIPTION OF THE DRAWINGS

The drawings are used to provide an understanding of the present disclosure, constitute a part of the specification, explain the present disclosure in conjunction with the embodiments of the present disclosure, and do not limit the present disclosure. In the drawings:

FIG. 1 shows a flowchart of a method for reducing false wake-up power consumption of a device according to some embodiments of the present disclosure;

FIG. 2a shows a schematic diagram of a preamble according to some embodiments of the present disclosure;

FIG. 2b shows a schematic diagram of a preamble being scrambled with a random factor according to some embodiments of the present disclosure;

FIG. 2c shows a schematic diagram of a preamble being scrambled with a random factor according to some embodiments of the present disclosure;

FIG. 2d shows a schematic diagram of a preamble being scrambled with a random factor according to some embodiments of the present disclosure;

FIG. 3 shows a flowchart of the sub-steps of step S4 according to some embodiments of the present disclosure;

FIG. 4 shows a schematic diagram of a device for reducing false wake-up power consumption according to some embodiments of the present disclosure;

FIG. 5 shows a schematic diagram of a device for reducing false wake-up power consumption according to some other embodiments of the present disclosure; and

FIG. 6 shows a schematic diagram of a system for reducing false wake-up power consumption according to some embodiments of the present disclosure.

### LIST OF REFERENCE NUMBERS

10: method
S1, S2, S3, S4, and S5: steps
Sᵤₚ: signal whose frequency increases over time
S_{down}: signal whose frequency decreases over time
TS11, TS12, and TS13: first time slices
TS121 and TS122: first sub-time slices
TS21, TS22, and TS23: second time slices
TS211, TS212, TS221, and TS222: second sub-time slices
S41, S42, S43, S44, S45, S46, and S47: sub-steps
100 and 200: devices
110: preamble detection module
120: wake-up packet recognition module
130: control module
131: information processing module
132: power management module
300: system

### DETAILED DESCRIPTION

In the following, only some exemplary embodiments are briefly described. The described embodiments may be modified in various different ways without departing from the spirit or scope of this disclosure, as would be appreciated by those skilled in the art. Accordingly, the drawings and descriptions are to be regarded as illustrative and not restrictive in nature.

In the description of this disclosure, it needs to be understood that the orientation or position relations denoted by such terms as “central” “longitudinal” “transverse” “length” “width” “thickness” “above” “below” “front” “rear” “left” “right” “vertical” “horizontal” “top” “bottom” “inside” “outside” “clockwise” “counterclockwise” and the like are based on the orientation or position relations as shown in the accompanying drawings, and are used only for the purpose of facilitating description of this disclosure and simplification of the description, instead of indicating or suggesting that the denoted devices or elements must be oriented specifically, or configured or operated in a specific orientation. Thus, such terms should not be construed to limit this disclosure. In addition, such terms as “first” and “second” are only used for the purpose of description, rather than indicating or suggesting relative importance or implicitly indicating the number of the denoted technical features. Accordingly, features defined with “first” and “second” may, expressly or implicitly, include one or more of the features. In the description of this disclosure, “a plurality of” means two or more, unless otherwise defined explicitly and specifically.

In the description of this disclosure, it needs to be noted that, unless otherwise specified and defined explicitly, such terms as “installation” “coupling” and “connection” should be broadly understood as, for example, a fixed connection, a detachable connection, or an integral connection; or a mechanical connection, an electrical connection or intercommunication; or a direct connection, or an indirect connection via an intermediary medium; or an internal communication between two elements or an interaction between two elements. For those skilled in the art, the specific meanings of such terms herein can be construed in light of the specific circumstances.

Herein, unless otherwise specified and defined explicitly, if a first feature is “on” or “beneath” a second feature, this may cover a direct contact between the first and second features, or a contact via another feature therebetween, other than the direct contact. Furthermore, if a first feature is “on”, “above”, or “over” a second feature, this may cover the case that the first feature is right above or obliquely above the second feature, or just indicate that the level of the first feature is higher than that of the second feature. If a first feature is “beneath”, “below”, or “under” a second feature, this may cover the case that the first feature is right below or obliquely below the second feature, or just indicate that the level of the first feature is lower than that of the second feature.

The disclosure below provides many different embodiments or examples so as to realize different structures of the disclosure. In order to simplify the disclosure herein, the following will give the description of the parts and arrangements in specific examples. Of course, they are only for the exemplary purpose, not intended to limit this disclosure. Besides, this disclosure may repeat a reference number and/or reference letter in different examples, and such repetition is for the purpose of simplification and clarity, which does not represent any relation among various embodiments and/or arrangements as discussed. In addition, this disclosure provides examples of various specific processes and materials, but those skilled in the art can also be aware of application of other processes and/or use of other materials.

The preferred embodiments of this disclosure will be described below with reference to the drawings. It should be appreciated that the preferred embodiments described here are only for the purpose of illustrating and explaining, instead of limiting, this disclosure.

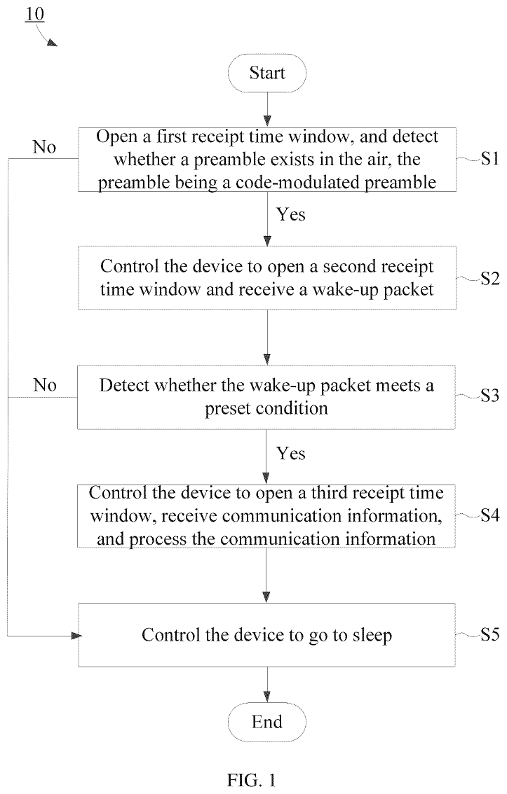

The present disclosure provides a method for reducing false wake-up power consumption of a device. FIG. 1 shows a flowchart of a method for reducing false wake-up power consumption of a device according to some embodiments of the present disclosure. As shown in FIG. 1, the method 10 includes steps S1 to S5. In step S1, a first receipt time window is opened, and whether a preamble exists in the air is detected, where the preamble is a code-modulated preamble. If no preamble is detected in the air, step S5 of controlling the device to go to sleep is executed. If the preamble is detected in the air, step S2 of controlling the device to open a second receipt time window and receive a wake-up packet is executed. In step S3, whether the wake-up packet meets a preset condition is detected (or determined). If the wake-up packet does not meet the preset condition, step S5 of controlling the device to go to sleep is executed. If the wake-up packet meets the preset condition, step S4 of controlling the device to open a third receipt time window, receive communication information and process the communication information is executed, and after communication information processing is completed, step S5 of controlling the device to go to sleep is executed. It should be noted that detecting whether a preamble exists in the air in step S1 means detecting whether a correct preamble exists in the air. Different from the preamble in the existing technologies, the preamble of the present disclosure is a code-modulated preamble, thereby reducing the probability of false wake-up of the device. In the present disclosure, by detecting whether the wake-up packet meets the preset condition, the device is controlled to go to sleep or the device is controlled to open the third receipt time window, receive the communication information, process the communication information, and go to sleep after communication information processing is completed, thereby reducing the probability of false wake-up of the device and reducing the false wake-up power consumption of the device. The method of the present disclosure will be described below in detail.

In step S1, a first receipt time window is opened, and whether a preamble exists in the air is detected, where the preamble is a code-modulated preamble. The first receipt time window is a time window for detecting whether a preamble exists in the air. The first time window is short and is generally of the order of milliseconds (ms).

In the present disclosure, the feature “opening a first receipt time window and detecting whether a preamble exists in the air” means detecting whether a preamble exists in the air in the first receipt time window. For example, when the device is in a sleeping mode, the device can be waked up periodically to detect whether a preamble exists in the air (i.e., the first receipt time window).

The feature “open a second receipt time window and receive a wake-up packet” and the feature “open a third receipt time window, receive communication information” have identical or similar meaning, and can be interpreted as “receive a wake-up packet in a second receipt time window” and “receive communication information in a third receipt time window respectively.”

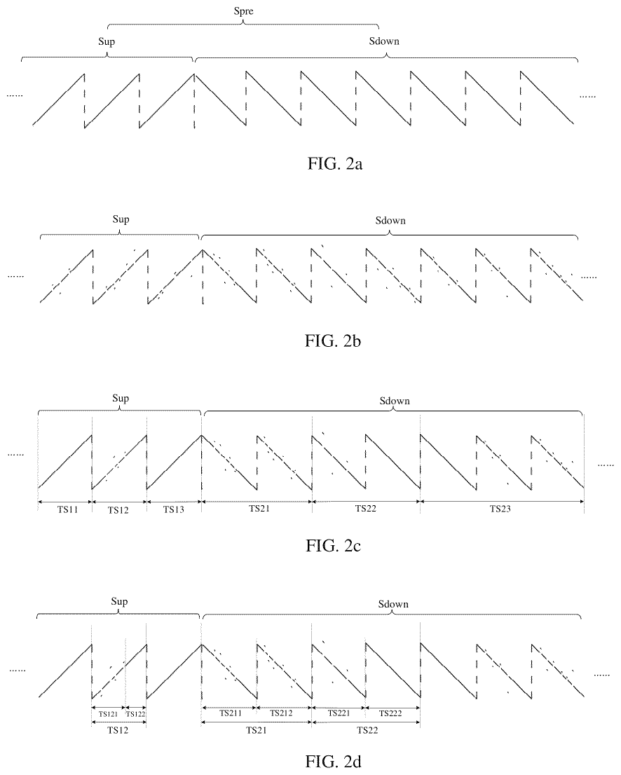

In some embodiments, the preamble includes a signal whose frequency increases over time and/or a signal whose frequency decreases over time. That is, the preamble may only include a signal whose frequency increases over time, the preamble may only include a signal whose frequency decreases over time, or the preamble may include both a signal whose frequency increases over time and a signal whose frequency decreases over time. FIG. 2a shows a schematic diagram of a preamble according to some embodiments of the present disclosure. As shown in FIG. 2a, the preamble Sₚᵣₑ includes a signal Sᵤₚ whose frequency increases over time and a signal S_{down} whose frequency decreases over time. It needs to be noted that in FIGS. 2a to 2d, the horizontal coordinates indicate time, and the vertical coordinates indicate the frequency.

The conventional preamble is a single-modulation preamble, all of which, for example, is an upchirp signal, from 0 to the maximum, repeatedly retransmitted. Such a preamble can easily lead to false wake-up of the device and increase the power consumption of the device. The present disclosure is not limited thereto. In the present disclosure, the preamble is optimized, and by adding a downchirp signal (see the signal S_{down} in FIG. 2a) on the basis of an upchirp signal (see the signal Sᵤₚ in FIG. 2a), the preamble is optimized to be a modulated signal with simple coding, thereby effectively reducing the probability of false wake-up of the device and reducing the false wake-up power consumption of the device.

In some embodiments, multiple devices may be present in one system, and in this case, the preambles of the devices are different from each other. For example, one or more ascending codes are added and/or one or more descending codes are added on the basis of repeating simple modulation code chip features. Coded modulation is performed in the above manner to enable the preambles of the devices to become different from each other. Therefore, the isolation between the preambles of the devices is increased. Even if the modulation modes of the devices are the same, the probability of false wake-up of the device can be effectively reduced, and the false wake-up power consumption of the device can be reduced, without reducing indicators such as the efficiency of the device to capture the preamble and the sensitivity of the device to receive the preamble.

In some embodiments, the method includes: scrambling the preamble with a random factor; and/or adding first group number information of the device to the preamble. In other words, the preamble in the present disclosure may be code modulated by scrambling the preamble with a random factor and/or by adding the first group number information of the device to the preamble. In this manner, stronger confidentiality and differentiation of the modulation information can be achieved, and the risk of being intercepted by information described by a fixed-value function can be reduced or even avoided, thereby enhancing the anti-false-wake-up capability of the device and improving the wake-up success rate of the device. The detail will be described below.

In some embodiments, the method includes: scrambling the preamble with a random factor. Specifically, the signal whose frequency increases over time and/or the signal whose frequency decreases over time may be scrambled with a random factor. That is, when the preamble is scrambled with a random factor, only the signal whose frequency increases over time may be scrambled, only the signal whose frequency decreases over time may be scrambled, or both the signal whose frequency increases over time and the signal whose frequency decreases over time may be scrambled.

FIG. 2b shows a schematic diagram of the preamble being scrambled through a random factor according to some embodiments of the present disclosure. As shown in FIG. 2b, for example, both the signal Sᵤₚ whose frequency increases over time and the signal S_{down} whose frequency decreases over time are scrambled with a random factor.

In some embodiment, the step of scrambling the signal whose frequency increases over time and/or the signal whose frequency decreases over time with a random factor includes: dividing the signal whose frequency increases over time into multiple first time slices and scrambling at least one of the multiple first time slices with a random factor; and/or dividing the signal whose frequency decreases over time into multiple second time slices and scrambling at least one of the multiple second time slices with a random factor.

That is, only the signal whose frequency increases over time may be divided into multiple first time slices, and one or more first time slices may be scrambled with a random factor. Alternatively, only the signal whose frequency decreases over time may be divided into multiple second time slices, and one or more second time slices may be scrambled with a random factor. Alternatively, the signal whose frequency increases over time may be divided into multiple first time slices, and one or more first time slices may be scrambled with a random factor; and the signal whose frequency decreases over time may be divided into multiple second time slices, and one or more second time slices may be scrambled with a random factor.

FIG. 2c shows a schematic diagram of a preamble being scrambled through a random factor according to some embodiments of the present disclosure. As shown in FIG. 2c, for example, the signal Sᵤₚ whose frequency increases over time is divided into multiple first time slices TS11, TS12, and TS13 (each first time slice includes, for example, at least one signal segment whose frequency increases over time, the length of each first time slice or the number of signal segments contained in each first time slice may be random or may be set, and, for example, each first time slice contains one signal segment whose frequency increases over time), and one or more first time slices are scrambled with a random factor (the number of selected first time slices may be random, the number may, for example, be 1, 2 or 3 or may be set, and, for example, all the first time slices are selected to be scrambled; the selected first time slices may also be random). In FIG. 2c, for example, the first time slice TS12 is scrambled. For another example, the signal S_{down} whose frequency decreases over time is divided into multiple second time slices TS21, TS22, and TS23 (each second time slice includes, for example, at least one signal segment whose frequency decreases over time, the length of each second time slice or the number of signal segments contained in each second time slice may be random or may be set, and, for example, each second time slice contains one signal segment whose frequency decreases over time), and one or more second time slices are scrambled with a random factor (the number of selected second time slices may be random, the number may, for example, be 1, 2 or 3 or may be set, and, for example, all the second time slices are selected to be scrambled; the selected second time slices may also be random). In FIG. 2c, for example, the second time slices TS21, TS22, and TS23 are scrambled.

In some embodiments, the step of scrambling at least one of the multiple first time slices with a random factor includes: dividing the at least one first time slice into multiple first sub-time slices, and scrambling at least one of the multiple first sub-time slices with a random factor. That is, the at least one first time slice may be divided into multiple first sub-time slices, and one or more first sub-time slices are scramble with a random factor. FIG. 2d shows a schematic diagram of a preamble being scrambled through a random factor according to some embodiments of the present disclosure. As shown in FIG. 2d, for example, the first time slice TS12 is further divided into multiple first sub-time slices TS121 and TS122 (the mutual ratio of the multiple first sub-time slices TS121 and TS122 may be random or may be set, for example, 1:1), and the first sub-time slice TS121 is scrambled with a random factor. When the first sub-time slice TS121 is scrambled, the frequency value at one or more random locations within the time range of the first sub-time slice TS121 may be changed, the frequency value may be increased or decreased, and the magnitude of the increase or decrease may be the same or different.

In some embodiments, the step of scrambling at least one of the multiple second time slices with a random factor includes: dividing the at least one second time slice into multiple second sub-time slices, and scrambling at least one of the multiple second sub-time slices with a random factor. That is, the at least one second time slice may be divided into multiple second sub-time slices, and one or more second sub-time slices are scrambled with a random factor. As shown in FIG. 2d, for example, the second time slice TS21 is divided into multiple second sub-time slices TS211 and TS212 (the mutual ratio of the multiple second sub-time slices TS211 and TS212 may be random or may be set, for example, 1:1), and the second sub-time slices TS211 and TS212 are scrambled with a random factor. For another example, the second time slice TS22 is divided into multiple second sub-time slices TS221 and TS222, and the second sub-time slice TS221 is scrambled with a random factor. When the second sub-time slice is scrambled, the frequency value at one or more random locations within the time range of the second sub-time slice may be changed, the frequency value may be increased or decreased, and the magnitude of the increase or decrease may be the same or different.

It needs to be noted that the signal whose frequency increases over time, the first time slice, the signal whose frequency decreases over time, and the second time slice may be randomly divided based on time into first time slices, first sub-time slices, second time slices, and second sub-time slices, respectively. That is, the time length and the number of the first time slices, the second time slices, the first sub-time slices, and the second sub-time slices may be random, and the time length and the number may be adjustable. Furthermore, the embodiments of FIGS. 2a to 2c are only exemplary illustrations, and the present disclosure is not limited thereto.

In some embodiments, the method includes: adding first group number information of the device to the preamble. Specifically, the first group number information of the device may be added to the signal whose frequency increases over time and/or the signal whose frequency decreases over time. For example, as shown in FIG. 2a or FIG. 2b, the first group number information of the device may only be added to the signal Sᵤₚ whose frequency increases over time. Alternatively, the first group number information of the device may only be added to the signal S_{down} whose frequency decreases over time. Alternatively, the first group number information of the device may be added to both the signal Sᵤₚ whose frequency increases over time and the signal S_{down} whose frequency decreases over time. The first group number information of the device may be a meaningful group number (for example, a region number, a building number, a floor number, a room number, and the like).

In some embodiment, the step of adding the first group number information of the device to the signal whose frequency increases over time and/or the signal whose frequency decreases over time includes: dividing the signal whose frequency increases over time into multiple first time slices, and adding the first group number information to at least one of the multiple first time slices; and/or dividing the signal whose frequency decreases over time into multiple second time slices, and adding the first group number information to at least one of the multiple second time slices. For example, as shown in FIG. 2c, the first group number information may be added to at least one of the first time slices TS11, TS12 or TS13. Alternatively, the first group number information may be added to at least one of the second time slices TS21, TS22, or TS23. Alternatively, the first group number information may be added to at least one of the first time slices TS11, TS12, or TS13 and to at least one of the second time slices TS21, TS22 or TS23.

In some embodiments, the step of adding the first group number information to at least one of the multiple first time slices includes: dividing the at least one first time slice into multiple first sub-time slices, and adding the first group number information to at least one of the multiple first sub-time slices. For example, as shown in FIG. 2d, the first group number information may be added to at least one of the first sub-time slices TS121 or TS122.

In some embodiments, the step of adding the first group number information to at least one of the multiple second time slices includes: dividing the at least one second time slice into multiple second sub-time slices, and adding the first group number information to at least one of the multiple second sub-time slices. For example, as shown in FIG. 2d, the first group number information may be added to at least one of the second sub-time slices TS211, TS212, TS221, or TS222.

The division of the first time slices, the second time slices, the first sub-time slices, and the second sub-time slices in the process of adding the group number information may be performed in basically the same manner as the division of the first time slices, the second time slices, the first sub-time slices, and the second sub-time slices in the process of scrambling as described above, which will not be repeated herein.

In the method of the present disclosure, the preamble may include a signal whose frequency increases over time and/or a signal whose frequency decreases over time. Preferably, the preamble may include both one or more signals whose frequency increases over time and one or more signals whose frequency decreases over time, so the probability of false wake-up of the device can be effectively reduced and the false wake-up power consumption of the device can be reduced.

In the method of the present disclosure, by inserting a random factor that is irregular and cannot be described by a function into the signal whose frequency increases over time and/or the signal whose frequency decreases over time for scrambling, the cryptographic characteristics of the device can be can enhanced, thereby reducing the probability and the power consumption of false wake-up of the device. For the receiver, by filtering interference factors and extracting original linear parameters through a known or preset random factor scrambling method, reception operations such as frequency bias estimation and time bias estimation may be performed, which solves the problem that the preamble signal has many similar devices, is easy to capture, and has weak encryption characteristics, thereby reducing the probability and the power consumption of false wake-up of the device and achieving stronger confidentiality.

In the method of the present disclosure, the first group number information of the device is added to the signal whose frequency increases over time and/or the signal whose frequency decreases over time. When the receiver performs continuous capture, the preamble linear signal and the group number information can be simultaneously demodulated, which can reduce the probability and power consumption of false wake-up of multiple devices in different groups and can achieve better and more efficient anti-false-wake-up capability of multiple devices in the same group, thereby achieving stronger confidentiality and differentiation capability.

In the method of the present disclosure, when the preamble is code modulated, a random factor and/or first group number information may be inserted into the signal whose frequency increases over time and/or the signal whose frequency decreases over time (a linearly modulated signal). A random factor and/or first group number information may be added to at least one first time slice and/or at least one second time slice and may be added to at least one first sub-time slice and/or at least one second sub-time slice. The receiving end may filter or parse the corresponding time slice or sub-time slice during subsequent demodulation. In this manner, different groups of devices can be differentiated at the preamble stage so that different devices in the same group and different devices in different groups will not be falsely woken up by similar successive modulated signals, thereby achieving stronger modulation confidentiality and differentiation and achieving a stronger anti-false-wake-up capability. At the same time, it helps to improve the success rate and efficiency of multiple devices in the same group being woken up.

In some embodiments, during subsequent demodulation at the receiving end, for the random factor, the receiver may remove the interference slice by filtering. Alternatively, at least part of the time slices may be prefabricated information, and the receiver may perform reduction processing according to a prefabrication algorithm to obtain the original preamble that has not been scrambled with a random factor. For the time information of effective modulation, the receiver may perform data reduction to obtain the time phase information of the original preamble, synchronize the time of receiving the preamble, and, at the same time, resolve the effective modulation information.

In some embodiments, the preamble may include a frequency-varying signal whose starting frequency is non-zero. That is, the frequency corresponding to time zero is not zero. It should be understood that when the starting frequency location is not zero, it represents that a signal includes effective information. In some embodiments, the method of the present disclosure further includes: scrambling the frequency-varying signal whose starting frequency is non-zero with a random factor; and/or adding the first group number information of the device to the frequency-varying signal whose starting frequency is non-zero. That is, the preamble may include effective information, and the effective information may be scrambled with a random factor; and/or the first group number information of the device is added to the effective information. In this manner, the coded modulation of the preamble can also be achieved. The specific implementation and the technical effects are similar to those of the aforementioned examples of scrambling the signal whose frequency increases over time and/or the signal whose frequency decreases over time with a random factor and the aforementioned examples of adding the first group number information of the device to the signal whose frequency increases over time and/or the signal whose frequency decreases over time, which will not be repeated herein.

In some existing schemes, an active detection mode is adopted, in which the device needs to be periodically woken up to detect whether a device in the surrounding environment sends a wake-up communication signal (whether a preamble exists in the air) and reports actively. Such a listening mechanism consumes a large amount of power. In the present disclosure, a passive detection mode may be adopted, in which the device does not need to be woken up, and in the case where the device is asleep, whether a preamble exists in the air is detected by periodically opening the first receipt time window, thereby significantly reducing the power consumption of the listening mechanism of the device. It should be noted that active detection may also be adopted in the present disclosure.

In some embodiments, the device may communicate with another device, and the preamble may be sent by another device that gives an alarm. For example, a device A may communicate with a device B, and when the device B gives an alarm, the device B may send a preamble. The device A may periodically open the first receipt time window and detect whether a preamble exists in the air. In some embodiments, the device and/or the another device may be a fire control device. In some embodiments, the device and/or the another device may also be a smart home device.

In some embodiments, if no preamble is detected in the air, step S5 of controlling the device to go to sleep is executed; if the preamble (the correct preamble) is detected in the air, step S2 of controlling the device to open a second receipt time window and receive a wake-up packet is executed, where the second receipt time window is longer than the first receipt time window. In step S3, whether the wake-up packet meets a preset condition is detected. It should be noted that the second receipt time window is a time window used for receiving a wake-up packet and is generally of the order of milliseconds (ms), and the wake-up packet may be disposed in a payload region.

In some embodiments, the device includes first group number information. The first group number information may be determined by one or more of a true random number, identity (ID) information of the device, and Universal Time Coordinated (UTC) time information. For example, the ID information of the device may be used as the first group number information of the device, the true random number and the ID information of the device may be used as the first group number information of the device, or the ID information of the device and the UTC time information may be used as the first group number information of the device. Preferably, the first group number information of the device may be determined through a weighted calculation based on the true random number, the ID information of the device, and the UTC time information when the device is first registered. It should be noted that the weights of the true random number, the ID information of the device, and the UTC time information are not limited by the present disclosure and are determined depending on the actual situation. By coding one or more of the true random number, the ID information of the device and the UTC time information, the repetition rate of the group number information of the device can be reduced, thereby reducing the probability of false wake-up of the device. For a system including multiple devices, the repetition rate of the group number information of each device can be reduced, thereby reducing the probability of false wake-up of each device and reducing the false wake-up power consumption of each device. It should be noted that the length of the wake-up packet is adjustable and may be flexibly adjusted according to the actual situation. In some embodiments, the wake-up packet may include 4 bytes of data, and the false report recognition probability may be 1 in 4,294,967,296.

In some embodiments, the wake-up packet includes second group number information. The step (step S3) of detecting whether the wake-up packet meets the preset condition includes: detecting whether the wake-up packet matches the device. The step of detecting whether the wake-up packet matches the device includes: detecting whether the second group number information of the wake-up packet matches the first group number information of the device. If the second group number information of the wake-up packet matches the first group number information of the device, it means that the wake-up packet meets the preset condition. Otherwise, if the second group number information of the wake-up packet does not match the first group number information of the device, it means that the wake-up packet does not meet the preset condition.

In some embodiments, the step of detecting whether the wake-up packet matches the device further includes: detecting whether the second group number information of the wake-up packet matches the preset group number information. If the second group number information of the wake-up packet matches the preset group number information, it means that the wake-up packet meets the preset condition. Otherwise, if the second group number information of the wake-up packet does not match the preset group number information, it means that the wake-up packet does not meet the preset condition. Whether the wake-up packet matches the device may also be detected in such a manner.

In some embodiments, the weights of the preset group number information and the first group number information may also be set respectively, and whether the wake-up packet matches the device is comprehensively detected based on the preset group number information and the first group number information.

If the wake-up packet does not meet the preset condition, step S5 of controlling the device to go to sleep is executed. If the wake-up packet meets the preset condition, step S4 of controlling the device to open a third receipt time window, receive communication information, and process the communication information is executed, and after communication information processing is completed, step S5 of controlling the device to go to sleep is executed. In the present disclosure, by detecting whether the wake-up packet meets the preset condition, the probability of a false wake-up of the device can be further reduced, and the false wake-up power consumption of the device can be further reduced.

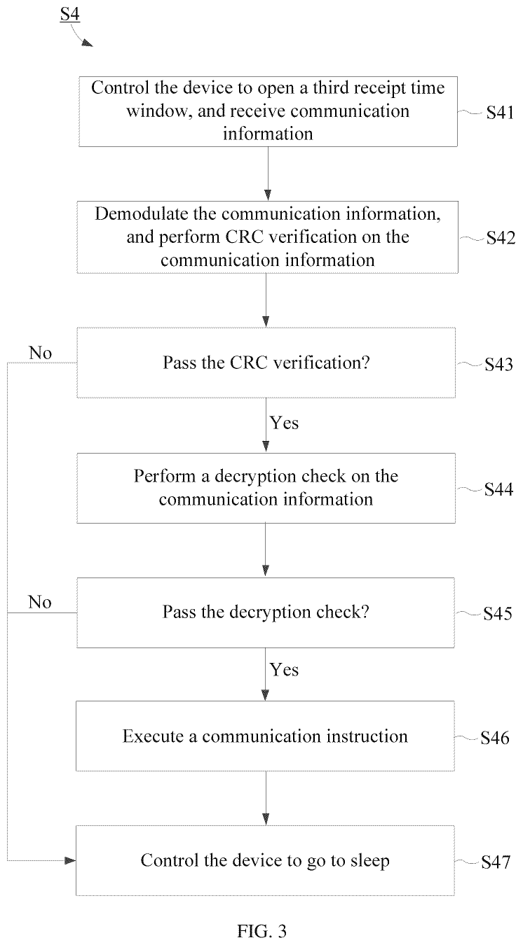

FIG. 3 shows the sub-steps of step S4 according to some embodiments of the present disclosure. As shown in FIG. 3, step S4 includes sub-steps S41 to S47, which will be described in detail below.

In sub-step S41, the device is controlled to open a third receipt time window and receive communication information, where the third receipt time window is longer than the second receipt time window and is generally of the order of seconds(s).

In sub-step S42, the communication information is demodulated, and cyclic redundancy check (CRC) verification is performed on the communication information.

In sub-step S43, whether the communication information passes the CRC verification is determined. If the communication information passes the CRC verification, sub-step S44 of performing a decryption check on the communication information is executed. If the communication information fails the CRC verification, sub-step S47 of controlling the device to go to sleep is executed.

In sub-step S45, whether the communication information passes the decryption check is determined. If the communication information passes the decryption check, sub-step S46 of demodulating payload information and executing a communication instruction is executed, and sub-step S47 of controlling the device to go to sleep is executed after the communication instruction is executed. If the communication information fails the decryption check, sub-step S47 of controlling the device to go to sleep is executed.

The sub-steps of step S4 are described above. As can be seen, the device wakes up only when the communication information passes both the CRC verification and the decryption check. If the communication information fails the CRC verification or fails the decryption check, the device does not wake up and remains asleep. In the present disclosure, by receiving and processing the communication information, the probability of false wake-up of the device can be further reduced, and the false wake-up power consumption of the device can be further reduced; by performing the CRC verification and the decryption check on the communication information, the wake-up success rate of the device can be improved.

The frequency shift of the device after a long period of operation can lead to the problem that a reference timer becomes inaccurate. In some embodiments, the device in the present disclosure may work in a TDMA periodic cycle mode. In each periodic sub-cycle, only the first receipt time window is opened, and whether a preamble exists in the air is detected. If the preamble is detected in the air, the second receipt time window is opened, a wake-up packet is received, and whether the wake-up packet meets a preset condition is detected. If the wake-up packet meets the preset condition, the third receipt time window is opened, and the communication information is received and processed. The third receipt time window may be 1.1 times a sub-cycle. The periodic sub-cycle may be, for example, 2.3 s, 3 s, 5 s, or 10 s. In the present disclosure, by working in the TDMA periodic cycle mode, no high-precision hardware clock circuit is required, the accurate time is not required to be set to control the opening and closing of the receipt window, and the precision of a built-in RC oscillator of the device can meet the requirements, thereby reducing the requirements for the reference timer, lowering the hardware cost and simplifying the complexity of the system.

In some embodiments, the method 10 further includes: monitoring the power consumption of the device, and controlling the device to perform the method 10 at low power consumption. Specifically, the power consumption of the device may be monitored to enable the above steps S1 to S5 to be executed at low power consumption, which is conducive to prolonging the service life of the battery of the device and reducing the frequency of battery replacement, thereby meeting the requirements of the market for an ultra-long standby service life of the battery in the fields of fire control and smart home, saving energy and protecting the environment.

It should be noted that the method 10 may also be executed at non-low power consumption. The method for reducing false wake-up power consumption of a device of the present disclosure is described above, and the present disclosure further provides a device for reducing false wake-up power consumption. In some embodiments, the device includes a fire control device, which may be, for example, a wireless smoke detector, a wireless CO detector, a wireless heat detector, a wireless manual alarm switch, a wireless combustible gas detector, a wireless sound-light detector, a wireless input/output module or a wireless input module. In some other embodiments, the device further includes a smart home device such as a wireless body detector, a wireless button, a wireless curtain motor, a wireless smart socket, a wireless door sensor, a wireless door/window sensor or a wireless humidity temperature monitor.

In some embodiments, through a wireless networking technique (for example, Wi-Fi, ZigBee, Bluetooth, NFC, etc.), multiple fire control devices may form a warning and alarm network, multiple smart home devices may form a smart home network, or one or more fire control devices and one or more smart home devices may form a smart home warning and alarm network. Such networks may be used for both domestic and commercial purposes.

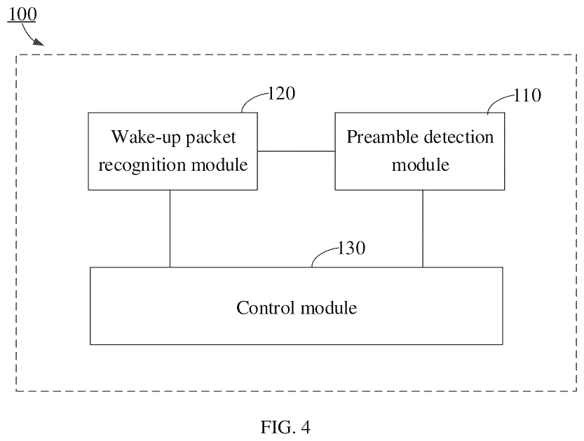

FIG. 4 shows a schematic diagram of a device 100 for reducing false wake-up power consumption according to some embodiments of the present disclosure. As shown in FIG. 4, the device 100 includes a preamble detection module 110, a wake-up packet recognition module 120, and a control module 130. The wake-up packet recognition module 120 communicates with the preamble detection module 110. The control module 130 communicates with the preamble detection module 110 and the wake-up packet recognition module 120, respectively, and is configured to control the operation of the preamble detection module 110 and the wake-up packet recognition module 120.

The preamble detection module 110 is configured to open a first receipt time window and detect whether a preamble exists in the air, where the preamble is a code-modulated preamble.

If the preamble detection module 110 detects the preamble in the air, the wake-up packet recognition module 120 is configured to open a second receipt time window, receive a wake-up packet, and detect whether the wake-up packet meets a preset condition.

If the wake-up packet recognition module 120 determines that the wake-up packet meets the preset condition, the control module 130 is configured to open a third receipt time window, receive communication information, process the communication information, and control the device 100 to go to sleep after communication information processing is completed.

The control module 130 is further configured to, if the preamble detection module 110 detects no preamble in the air, or if the wake-up packet recognition module 120 determines that the wake-up packet does not meet the preset condition, control the device 100 to go to sleep.

In some embodiments, the control module 130 is further configured to scramble the preamble with a random factor; and/or add first group number information of the device to the preamble.

In some embodiments, the preamble includes a signal whose frequency increases over time and/or a signal whose frequency decreases over time. The control module 130 is further configured to scramble the signal whose frequency increases over time and/or the signal whose frequency decreases over time with a random factor.

In some embodiments, the control module 130 is further configured to divide the signal whose frequency increases over time into multiple first time slices, and scramble at least one of the multiple first time slices with a random factor; and/or divide the signal whose frequency decreases over time into multiple second time slices, and scramble at least one of the multiple second time slices with a random factor.

In some embodiments, the control module 130 is further configured to divide the at least one first time slice into multiple first sub-time slices, and scramble at least one of the multiple first sub-time slices with a random factor; and/or divide the at least one second time slice into multiple second sub-time slices, and scramble at least one of the multiple second sub-time slices with a random factor.

In some embodiments, the control module 130 is further configured to add the first group number information of the device to the signal whose frequency increases over time and/or the signal whose frequency decreases over time.

In some embodiments, the control module 130 is further configured to divide the signal whose frequency increases over time into multiple first time slices, and add the first group number information to at least one of the multiple first time slices; and/or divide the signal whose frequency decreases over time into multiple second time slices, and add the first group number information to at least one of the multiple second time slices.

In some embodiments, the control module 130 is further configured to divide the at least one first time slice into multiple first sub-time slices, and add the first group number information to at least one of the multiple first sub-time slices; and/or divide the at least one second time slice into multiple second sub-time slices, and add the first group number information to at least one of the multiple second sub-time slices.

In some embodiments, the preamble includes a frequency-varying signal whose starting frequency is non-zero. The control module 130 is further configured to scramble the frequency-varying signal whose starting frequency is non-zero with a random factor; and/or add the first group number information of the device to the frequency-varying signal whose starting frequency is non-zero.

In some embodiments, the wake-up packet recognition module 120 is configured to detect whether the wake-up packet matches the device, to detect whether the wake-up packet meets the preset condition.

In some embodiments, the device includes first group number information, the wake-up packet includes second group number information, and the wake-up packet recognition module is configured to detect whether the second group number information of the wake-up packet matches the first group number information of the device, to detect whether the wake-up packet matches the device; and/or detect whether the second group number information of the wake-up packet matches preset group number information, to detect whether the wake-up packet matches the device.

In some embodiments, the first group number information is determined by one or more of a true random number, ID information of the device, and UTC time information.

In some embodiments, the third receipt time window is longer than the second receipt time window.

In some embodiments, the preamble detection module is configured to periodically open the first receipt time window and detect whether the preamble exists in the air, where the first receipt time window is shorter than the second receipt time window.

In some embodiments, the control module is configured to demodulate the communication information, and perform CRC verification on the communication information; if the communication information passes the CRC verification, perform a decryption check on the communication information, and if the communication information passes the decryption check, control the device to go to sleep after the device executes a communication instruction; if the communication information fails the CRC verification, or if the communication information fails the decryption check, control the device to go to sleep.

In some embodiments, the device is capable of communicating with another device, and the preamble may be sent by the another device that gives an alarm. In this case, the device is equivalent to a receiver, and the another device is equivalent to a transmitter.

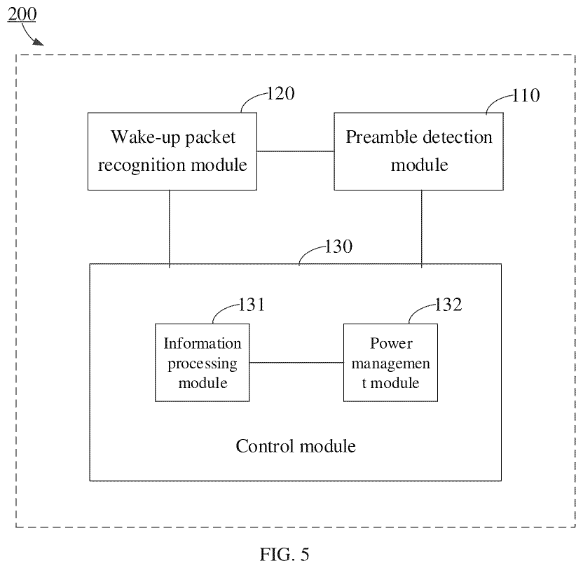

FIG. 5 shows a schematic diagram of a device 200 for reducing false wake-up power consumption according to some other embodiments of the present disclosure. As shown in FIG. 5, the device 200 further includes a power management module 132. The power management module 132 is configured to monitor the power consumption of the device 200, to enable the preamble detection module 110, the wake-up packet recognition module 120 and the control module 130 to work at low power consumption.

In some embodiments, the device 200 may further include a primary power (not shown in the figure) and a backup power (not shown in the figure). The primary power and the backup power may be separately coupled to the power management module 132. The power management module 132 may monitor and manage the operation of the primary power and the backup power.

In some embodiments, for example, in normal cases, the power management module 132 may control the primary power to supply power to the device 200, to enable the device 200 to execute the method 10 described above.

In some embodiments, for example, in normal cases, the power management module 132 may control the backup power to operate at low power consumption so that the backup power can maintain its endurance and prolong its service life to cope with emergency situations.

In some embodiments, for example, in the event of an emergency such as a fire, the power management module 132 may control the backup power to supply power to the device 200, so that the device with a wireless sound-light detector can work in an emergency and give sound-light alarm information in time to inform the user to evacuate, thereby ensuring the safety of the user.

In some embodiments, the primary power and/or the backup power may be a primary battery (a dry battery) or may be a secondary battery (a rechargeable battery). The specific types of primary and secondary batteries are not limited by the present disclosure and are determined depending on the actual situation.

The location where the power management module 132 is disposed is not limited by the present disclosure. In some embodiments, as shown in FIG. 5, the power management module 132 may be built into the control module 130 and is integrated with the control module 130. In some other embodiments, although not shown in the figure, the power management module 132 may be disposed outside the control module 130 and is coupled to the control module 130. The above settings are within the protection scope of the present disclosure.

In some embodiments, as shown in FIG. 5, the device 200 may further include an information processing module 131. The information processing module 131 is coupled to the power management module 132 and is configured to execute at least some of the sub-steps in step S4 described above, for example, to execute sub-steps S41 to S46 described above.

The location where the information processing module 131 is disposed is not limited by the present disclosure. In some embodiments, as shown in FIG. 5, the information processing module 131 may be built into the control module 130, integrated with the control module 130, and coupled to the power management module 132. In some other embodiments, although not shown in the figure, the information processing module 131 may be disposed outside the control module 130 and is coupled to the control module 130. The above settings are within the protection scope of the present disclosure.

The device for reducing false wake-up power consumption of the present disclosure is described above. It should be noted that, although several modules of the device are mentioned in the above detailed description, such a division is not mandatory. In practice, according to the implementations of the present disclosure, the features and functions of two or more of the modules described above may be implemented in a single module. Conversely, the features and functions of one module described above may be further divided into multiple modules to be embodied.

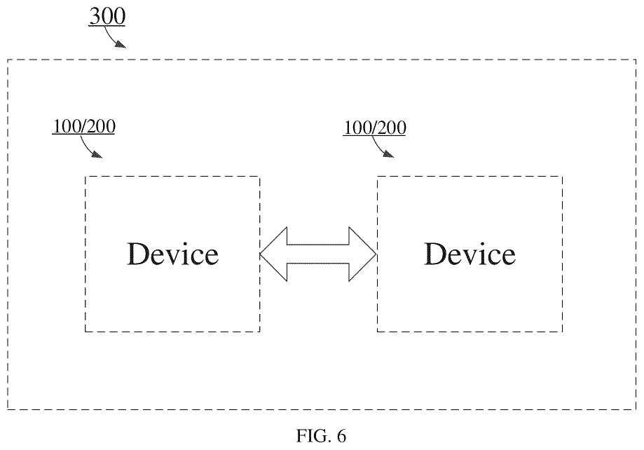

The present disclosure further relates to a system for reducing false wake-up power consumption. FIG. 6 shows a schematic diagram of a system 300 for reducing false wake-up power consumption according to some embodiments of the present disclosure. As shown in FIG. 6, the system 300 includes multiple devices 100/200 described above, wherein each device is capable of executing the method 10 described above in the case where another device gives an alarm and sends a preamble.

It should be noted that the situation in which the system 300 shown in FIG. 6 includes two devices 100/200 is only an exemplary illustration and does not constitute a limitation on the present disclosure. In fact, the system 300 may include a greater number of devices 100/200, and in the case where any one or more of these devices gives an alarm and sends a preamble, the other devices may all execute the method 10 described above.

In some embodiments, the method 10 of the present disclosure may be in the form of program code. The program code may be embodied in physical media, such as floppy disks, compact discs, hard drives, or any other machine-readable (for example, computer-readable) storage media, or is not limited to computer program products with any external form, where, when the program code is loaded into and executed by a machine, such as a computer, the machine thereby becomes an apparatus for participating the present disclosure. The program code may also be transmitted over some transmission medium, such as electrical wiring or cabling, through fiber optics, or via any other form of transmission, where, when the program code is received, loaded into, and executed by a machine such as a computer, the machine thereby becomes an apparatus for practicing the present disclosure. When implemented on a general-purpose processing unit, the program code combines with the processing unit to provide a unique apparatus that operates analogously to application-specific logic circuits.

In some embodiments, the control module/information processing module/processor/processing unit may include a central processing unit (CPU) or a micro control unit (MCU), and may further include another general-purpose processor, a digital signal processor (DSP), an application-specific integrated circuit (ASIC), a field-programmable gate array (FPGA) or another programmable logic device, a discrete gate or transistor logic device, a discrete hardware component, or the like.

The present disclosure further relates to a computer-readable storage medium including computer-executable instructions stored thereon, where the executable instructions, when executed by a processor, execute the method 10 described above.

In some embodiments, the computer-readable storage medium may be any tangible medium containing or storing a program for use by or in connection with an instruction execution system, apparatus, or device. The computer-readable storage medium includes, but is not limited to, an electrical, magnetic, optical or semiconductor form or apparatus, and the specific examples (a non-exhaustive list) include an electrical connection having one or more wires, a portable computer hard disk, a hard disk, a random-access memory (RAM), a non-volatile random-access memory (NRAM), a read-only memory (ROM), an erasable programmable read-only memory (EPROM, or a flash memory), an optical fiber, a portable compact disc read-only memory (CD-ROM), an optical memory, a magnetic memory or any suitable combination thereof.

In summary, the method, device and system of the present disclosure are described in detail. In the schemes of the present disclosure, by optimizing the preamble and by adopting a code-modulated preamble, the probability of false wake-up of the device can be effectively reduced, and the false wake-up power consumption of the device can be reduced; by setting a wake-up packet, the problem that the devices within the same modulation system misrecognize each other can be solved, the probability of false wake-up of the device can be further reduced, and the false wake-up power consumption of the device can be further reduced; by optimizing the periodic detection and working in a TDMA periodic cycle mode, the time slice of the transmitter, the preamble or the packet time are not required to be concerned with, no high-precision hardware clock circuit is required, and the hardware cost and volume of the device can be reduced; the device or system of the present disclosure supports battery-powered operation and low-power operation, which is conducive to prolonging the service life of the battery and reducing the frequency of battery replacement, thereby meeting the requirements of the market for an ultra-long standby service life of the battery. The schemes of the present disclosure can be applied in the fields of fire control and smart home and have a wide range of applications, and multiple devices can freely form a non-cellular network, providing a high degree of flexibility. Compared to the existing technologies, the schemes of the present disclosure have a low probability of false wake-up, low power consumption, a wide range of applications and a high degree of flexibility, thereby meeting the requirements for low power consumption and long standby duration, and when applied to the fire control equipment, can reduce the risk of warning and alarm failures of the fire control equipment, thereby providing a security guarantee for fire control.

It should be noted that the specification herein provides the method operation steps described in the embodiments or the schematic diagrams, but based on the conventional or uninventive work, more or less operation steps may be included. The step sequence enumerated in the embodiments is only one of various step execution sequences and does not represent a unique execution sequence. When the method operation steps are executed in a system or device product in practice, the method operation steps may be executed according to the method sequence shown in the embodiments or the flowcharts or in parallel.

It should be noted that although a number of modules of the device/system are mentioned in the detailed description above, this division is merely not mandatory. In practice, according to the implementations of the present disclosure, the features and functions of two or more of the modules described above may be implemented in a single module. Conversely, the features and functions of one module described above may be further divided into multiple modules to be embodied.

It needs to be noted that the present disclosure may only include any one or more features of any one or more embodiments of FIGS. 1 to 6. In other words, not all of the features illustrated herein need to be implemented simultaneously in the methods, devices, and systems of the present disclosure.

Finally, it should be noted that the above are merely preferred embodiments of the present disclosure and are not intended to limit the present disclosure. Although the present disclosure is described in detail with reference to the embodiments described above, those skilled in the art can still modify the technical schemes described in the embodiments described above or make equivalent substitutions on some of the technical features therein. Any modifications, equivalent substitutions, improvements and the like made within the spirit and principle of the present disclosure fall within the protection scope of the present disclosure.

1. A method for reducing false wake-up power consumption of a device, comprising:
opening a first receipt time window, and detecting whether a preamble exists in air, wherein the preamble is a code-modulated preamble;
if no preamble is detected in the air, controlling the device to go to sleep;
if the preamble is detected in the air, controlling the device to open a second receipt time window and receive a wake-up packet;
detecting whether the wake-up packet meets a preset condition;
if the wake-up packet does not meet the preset condition, controlling the device to go to sleep; and
if the wake-up packet meets the preset condition, controlling the device to open a third receipt time window, receive communication information, process the communication information, and go to sleep after communication information processing is completed.

2. The method according to claim 1, comprising:
scrambling the preamble with a random factor; and/or
adding first group number information of the device to the preamble.

3. The method according to claim 2, wherein the preamble comprises a signal whose frequency increases over time and/or a signal whose frequency decreases over time, and a step of scrambling the preamble with a random factor comprises: scrambling the signal whose frequency increases over time and/or the signal whose frequency decreases over time with a random factor,
wherein a step of scrambling the signal whose frequency increases over time and/or the signal whose frequency decreases over time with a random factor comprises:
dividing the signal whose frequency increases over time into a plurality of first time slices, and scrambling at least one of the plurality of first time slices with a random factor; and/or
dividing the signal whose frequency decreases over time into a plurality of second time slices, and scrambling at least one of the plurality of second time slices with a random factor,
wherein a step of scrambling at least one of the plurality of first time slices with a random factor comprises: dividing the at least one first time slice into a plurality of first sub-time slices, and scrambling at least one of the plurality of first sub-time slices with a random factor; and
wherein a step of scrambling at least one of the plurality of second time slices with a random factor comprises: dividing the at least one second time slice into a plurality of second sub-time slices, and scrambling at least one of the plurality of second sub-time slices with a random factor.

4. The method according to claim 2, wherein a step of adding first group number information of the device to the preamble comprises: adding the first group number information of the device to the signal whose frequency increases over time and/or the signal whose frequency decreases over time.

5. The method according to claim 4, wherein a step of adding the first group number information of the device to the signal whose frequency increases over time and/or the signal whose frequency decreases over time comprises:
dividing the signal whose frequency increases over time into a plurality of first time slices, and adding the first group number information to at least one of the plurality of first time slices; and/or
dividing the signal whose frequency decreases over time into a plurality of second time slices, and adding the first group number information to at least one of the plurality of second time slices,
wherein a step of adding the first group number information to at least one of the plurality of first time slices comprises: dividing the at least one first time slice into a plurality of first sub-time slices, and adding the first group number information to at least one of the plurality of first sub-time slices; and
wherein a step of adding the first group number information to at least one of the plurality of second time slices comprises: dividing the at least one second time slice into a plurality of second sub-time slices, and adding the first group number information to at least one of the plurality of second sub-time slices.

6. The method according to claim 2, wherein the preamble comprises a frequency-varying signal whose starting frequency is non-zero, and the method comprises:
scrambling the frequency-varying signal whose starting frequency is non-zero with a random factor; and/or
adding the first group number information of the device to the frequency-varying signal whose starting frequency is non-zero.

7. The method according to claim 1, wherein a step of detecting whether the wake-up packet meets a preset condition comprises: detecting whether the wake-up packet matches the device,
wherein the device comprises first group number information; the wake-up packet comprises second group number information; a step of detecting whether the wake-up packet matches the device comprises: detecting whether the second group number information of the wake-up packet matches the first group number information of the device; and/or detecting whether the second group number information of the wake-up packet matches preset group number information, to detect whether the wake-up packet matches the device,
wherein the first group number information is determined by one or more of a true random number, identity (ID) information of the device, and Universal Time Coordinated (UTC) time information.

8. The method according to claim 1, wherein the third receipt time window is longer than the second receipt time window,
wherein a step of detecting whether a preamble exists in air comprises: periodically opening the first receipt time window, and detecting whether the preamble exists in the air, wherein the first receipt time window is shorter than the second receipt time window,
wherein a step of receiving communication information and processing the communication information comprises: demodulating the communication information, and performing cyclic redundancy check (CRC) verification on the communication information; if the communication information passes the CRC verification, performing a decryption check on the communication information, and if the communication information passes the decryption check, controlling the device to go to sleep after the device executes a communication instruction; if the communication information fails the CRC verification or if the communication information fails the decryption check, controlling the device to go to sleep.

9. The method according to claim 1, wherein the device is capable of communicating with another device; the preamble is capable of being sent by the another device that gives an alarm; wherein the device and/or the another device comprises a fire control device,
the method further comprising: monitoring power consumption of the device, and controlling the device to perform the method at low power consumption.

10. A device for reducing false wake-up power consumption, comprising:
a preamble detection module;
a wake-up packet recognition module communicating with the preamble detection module; and
a control module communicating with the preamble detection module and the wake-up packet recognition module respectively and controlling operation of the preamble detection module and the wake-up packet recognition module;
wherein the preamble detection module is configured to open a first receipt time window and detect whether a preamble exists in the air, wherein the preamble is a code-modulated preamble;
if the preamble detection module detects the preamble in the air, the wake-up packet recognition module is configured to open a second receipt time window, receive a wake-up packet, and detect whether the wake-up packet meets a preset condition;
if the wake-up packet recognition module determines that the wake-up packet meets the preset condition, the control module is configured to open a third receipt time window, receive communication information, process the communication information and control the device to go to sleep after communication information processing is completed;
the control module is further configured to, if the preamble detection module detects no preamble in the air, or if the wake-up packet recognition module determines that the wake-up packet does not meet the preset condition, control the device to go to sleep.

11. The device according to claim 10, wherein the control module is further configured to:
scramble the preamble with a random factor; and/or
add first group number information of the device to the preamble.

12. The device according to claim 11, wherein the preamble comprises a signal whose frequency increases over time and/or a signal whose frequency decreases over time, and the control module is further configured to scramble the signal whose frequency increases over time and/or the signal whose frequency decreases over time with a random factor,
wherein the control module is further configured to:
divide the signal whose frequency increases over time into a plurality of first time slices, and scramble at least one of the plurality of first time slices with a random factor; and/or
divide the signal whose frequency decreases over time into a plurality of second time slices, and scramble at least one of the plurality of second time slices with a random factor.

13. The device according to claim 12, wherein the control module is further configured to:
divide the at least one first time slice into a plurality of first sub-time slices, and scramble at least one of the plurality of first sub-time slices with a random factor; and/or
divide the at least one second time slice into a plurality of second sub-time slices, and scramble at least one of the plurality of second sub-time slices with a random factor.

14. The device according to claim 11, wherein the control module is further configured to:
add the first group number information of the device to the signal whose frequency increases over time and/or the signal whose frequency decreases over time.

15. The device according to claim 14, wherein the control module is further configured to:
divide the signal whose frequency increases over time into a plurality of first time slices, and add the first group number information to at least one of the plurality of first time slices; and/or
divide the signal whose frequency decreases over time into a plurality of second time slices, and add the first group number information to at least one of the plurality of second time slices,
wherein the control module is further configured to:
divide the at least one first time slice into a plurality of first sub-time slices, and add the first group number information to at least one of the plurality of first sub-time slices; and/or
divide the at least one second time slice into a plurality of second sub-time slices, and add the first group number information to at least one of the plurality of second sub-time slices.

16. The device according to claim 11, wherein the preamble comprises a frequency-varying signal whose starting frequency is non-zero, and the control module is further configured to:
scramble the frequency-varying signal whose starting frequency is non-zero with a random factor; and/or
add the first group number information of the device to the frequency-varying signal whose starting frequency is non-zero.

17. The device according to claim 10, wherein the wake-up packet recognition module is configured to detect whether the wake-up packet matches the device, to detect whether the wake-up packet meets the preset condition,
wherein the device comprises first group number information; the wake-up packet comprises second group number information; the wake-up packet recognition module is configured to detect whether the second group number information of the wake-up packet matches the first group number information of the device, to detect whether the wake-up packet matches the device; and/or detect whether the second group number information of the wake-up packet matches preset group number information, to detect whether the wake-up packet matches the device,
wherein the first group number information is determined by one or more of a true random number, identity (ID) information of the device, and Universal Time Coordinated (UTC) time information.

18. The device according to claim 10, wherein the third receipt time window is longer than the second receipt time window,
wherein the preamble detection module is configured to periodically open the first receipt time window and detect whether the preamble exists in the air, wherein the first receipt time window is shorter than the second receipt time window,
wherein the control module is configured to demodulate the communication information, and perform cyclic redundancy check (CRC) verification on the communication information; if the communication information passes the CRC verification, perform a decryption check on the communication information, and if the communication information passes the decryption check, control the device to go to sleep after the device executes a communication instruction; if the communication information fails the CRC verification, or if the communication information fails the decryption check, control the device to go to sleep.

19. The device according to claim 10, wherein the device is capable of communicating with another device; the preamble is capable of being sent by the another device that gives an alarm;
wherein the device and/or the another device comprises a fire control device, the device further comprising a power management module, wherein the power management module is configured to monitor power consumption of the device, to enable the preamble detection module, the wake-up packet recognition module and the control module to work at low power consumption.

20. A computer-readable storage medium comprising computer-executable instructions stored thereon, wherein the executable instructions, when executed by a processor, implement a method for reducing false wake-up power consumption of a device, the method comprising:
opening a first receipt time window, and detecting whether a preamble exists in air, wherein the preamble is a code-modulated preamble;
if no preamble is detected in the air, controlling the device to go to sleep;
if the preamble is detected in the air, controlling the device to open a second receipt time window and receive a wake-up packet;
detecting whether the wake-up packet meets a preset condition;
if the wake-up packet does not meet the preset condition, controlling the device to go to sleep; and
if the wake-up packet meets the preset condition, controlling the device to open a third receipt time window, receive communication information, process the communication information, and go to sleep after communication information processing is completed.
